(19) United States
(12) Patent Application Publication
(10) Pub. No.: US 2021/0081309 A1
(43) Pub. Date: Mar. 18, 2021

(54) MAPPING INTERACTIVE ELEMENTS IN AN APPLICATION USER INTERFACE

(71) Applicant: TestRigor, Inc., San Francisco, CA (US)

(72) Inventor: Artem Golubev, San Francisco, CA (US)

(21) Appl. No.: 17/017,343

(22) Filed: Sep. 10, 2020

Related U.S. Application Data
(60) Provisional application No. 62/900,167, filed on Sep. 13, 2019.

(51) Int. Cl. G06F 11/36; G06F 11/07; G06F 3/0481; G06F 11/32

(52) U.S. Cl. CPC G06F 11/3688; G06F 11/3684; G06F 11/327; G06F 11/3692; G06F 3/0481; G06F 11/0772

(57) ABSTRACT

A technique is introduced for mapping interactive elements in an application user interface as part of an automated testing process. In an example embodiment, the introduced technique includes crawling a graphical user interface (GUI) of a target application being tested, identifying interactive elements on multiple pages of the GUI based on the crawling, comparing properties of the interactive elements, and determining correspondences between interactive elements on different pages of the GUI based on the comparison of properties. In some embodiments, the introduced technique additionally includes generating element map data that is indicative of the identified correspondences between interactive elements. This element map data can then be used to, for example, detect errors in the GUI of the target application and/or detect when a test executor has returned to a previously accessed page in the GUI of the target application.

### CROSS-REFERENCE TO RELATED APPLICATIONS

This application claims the benefit of U.S. Provisional Application No. 62/900,167 titled, “MAPPING INTERACTIVE ELEMENTS IN AN APPLICATION USER INTERFACE,” filed on Sep. 13, 2019, the contents of which are hereby incorporated by reference in their entirety for all purposes. This application is therefore entitled to a priority date of Sep. 13, 2019.

### BACKGROUND

Newly developed software applications typically require extensive testing to eliminate bugs and other errors before deployment for access by end users. In practice, the testing of user interfaces associated with applications can be particularly challenging. Several approaches have been implemented to test the user interface functionality of applications. A traditional approach involves the use of human quality assurance (QA) testers to manually interact with an application to identify bugs and other errors. Manual QA testing can be expensive and time consuming and can lead to inconsistent results since human testers are prone to mistakes. To address some shortcomings of manual testing, several tools (e.g., Selenium™, Appium™, and Calabash™) have been developed to automate the process. While existing automation tools can alleviate the need for extensive manual testing, such tools can present new issues. For example, existing automated testing tools require continued support to ensure that the automated tests still work within a framework of an application being tested. For example, if the framework of an application changes (e.g., in an updated version), a program for performing an automated test of the application will itself need to be updated. Further, both manual testing and existing automation tools typically provide poor testing coverage since they are limited by existing knowledge of the functionality of the application. Human QA testers will usually only cover what is described in a defined test case. Similarly, existing automation tools will only cover what is defined in their automation scripts.

### BRIEF DESCRIPTION OF THE DRAWINGS

FIG. 1 is a block diagram illustrating an example networked computing environment in which certain embodiments of the introduced technique can be implemented;

FIG. 2 is a block diagram illustrating another example computing environment in which the introduced technique can be implemented;

FIG. 3 is a block diagram illustrating a high-level architecture of an example automated testing platform;

FIG. 4 is an architecture flow diagram illustrating an example automated testing process;

FIG. 5 is a block diagram illustrating, at a high level, the concept of comparing interactive elements between different pages of an application GUI;

FIG. 6 is a diagram illustrating the use of a matrix of similarity values to map corresponding interactive elements in different pages of an application GUI;

FIG. 7 shows several matrices of similarity values that present error conditions;

FIG. 8 is a flow diagram illustrating an example process for identifying correspondences between interactive elements using a matrix of similarity values;

FIG. 9 is an architecture flow diagram illustrating an example automated testing process that includes the introduced technique for mapping interactive elements in a GUI of a target application;

FIG. 10 is a flow diagram of an example process for mapping interactive elements in a GUI of a target application;

FIG. 11 is a flow diagram of an example process for detecting errors in a target application based on element map data;

FIG. 12 is a flow diagram of an example process for determining that a previously accessed page of a GUI is the same as a subsequently accessed page of the GUI based on element map data; and

FIGS. 13-21 show a series of screens associated with an example GUI associated with an automated testing platform.

### DETAILED DESCRIPTION

### Overview

Automated application testing has several benefits over more traditional manual approaches. However, existing automation tools are still limited in their ability to detect errors or other issues in an application during testing. Performing automated testing of a graphical user interface (GUI) of an application can be particularly challenging, for example, due to the difficulty of comparing different pages in the GUI. Consider, for example, an automated testing process that involves crawling a GUI of an application and interacting with the various interactive elements of the GUI. Interacting with GUI may cause transitions between pages (also referred to as “screens”) of the GUI. For example, in response to pressing a button on a first page of the GUI, the application may transition to a second page of the GUI. This presents a challenge from a testing standpoint since the entity performing the automated test will not have information regarding how certain interactive elements on one page correspond to elements on another page. For example, the entity performing the automated test may not have an understanding of whether a button pressed on the first page of the GUI also appears on the second page of the GUI. This issue of comparing pages in an application GUI can arise in several different contexts during an automated test. For example, when reproducing a sequence of steps during an automated test, the testing entity may need to detect whether an interactive element such as a button is missing. As another example, when performing a sequence of steps during an automated test, the testing entity may need to detect whether it has returned to a previously visited page. These are just some example scenarios that illustrate how the comparison of pages may impact an automated test.

To address these challenges and the limitations of exiting automation tools, a technique is introduced for mapping interactive elements in an application user interface. In an example embodiment, the introduced technique includes crawling a GUI of a target application, identifying interactive elements on multiple pages of the GUI based on the crawling, comparing properties of the interactive elements, and determining correspondences between interactive elements on different pages of the GUI based on the comparison of properties. In some embodiments, the introduced technique additionally includes generating element map data that is indicative of the identified correspondences between interactive elements. This element map data can then be used to, for example, detect errors in the GUI of the target application and/or detect when a test executor has returned to a previously accessed page in the GUI of the target application.

### Automated Testing Platform

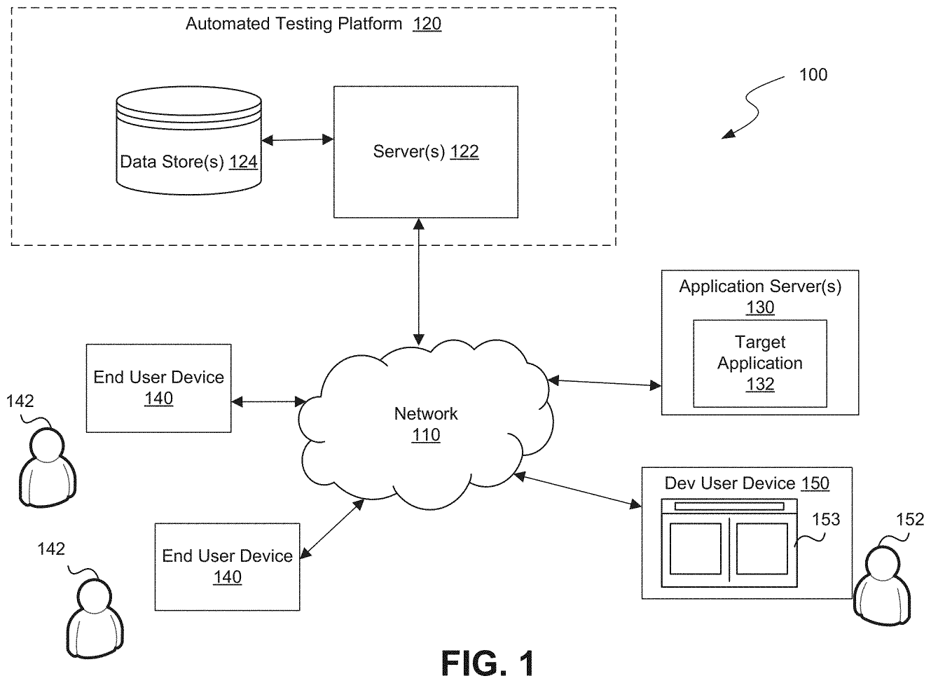

FIG. 1 is a block diagram illustrating an embodiment of a networked computing environment 100 in which certain embodiments of the introduced technique can be implemented. As shown in FIG. 1, the example networked computing environment 100 includes an automated testing platform 120 for performing automated testing of a target application 132, according to the introduced technique.

The example networked computing environment 100 depicted in FIG. 1 includes a network 110 over which various network-connected computing devices and systems are capable of communicating. Network 110 can include a single distinct network or can include a collection of distinct networks operating wholly or partially in conjunction to provide connectivity between network-connected computing systems. For example, network 110 may include one or more of a wired or wireless local area network (LAN), a wired or wireless wide area network (WAN), a cellular data network, or any other appropriate communication network. Further, the one or more networks can include open networks (e.g., the Internet) and/or private networks (e.g., an intranet and/or an extranet). Communication between network-connected computing systems over network 110 may be over any known communication protocol or model such as the Internet Protocol Suite (i.e., TCP/IP), the Open System Interconnections (OSI) model, the User Datagram Protocol (UDP), the File Transfer Protocol (FTP), etc.

The automated testing platform 120 may include one or more server computer systems 122 with processing capabilities for performing embodiments of the introduced technique. The automated testing platform 120 may also include non-transitory processor-readable storage media or other data storage facilities for storing instructions that are executed by a processor and/or storing other data utilized when performing embodiments of the introduced technique. For example, the automated testing platform 120 may include one or more data store(s) 124 for storing data. Data store 124 may represent any type of machine-readable capable of storing structure and/or unstructured data. Data stored at data store 124 may include, for example, image data (e.g., screen captures), video data, audio data, machine learning models, testing scenario data, recorded user interaction data, testing files (e.g., copies of a target application), etc. Note that the term “data store” is used for illustrative simplicity to refer to data storage facilities, but shall be understood to include any one or more of a database, a data warehouse, a data lake, a data mart, data repository, etc.

While illustrated in FIG. 1 as a single server computer system 122 and associated data store 124, many implementations may employ two or more server computer systems 122 and/or data stores 124. Further, the server computer systems 122 depicted in FIG. 1 may represent physical computing devices and/or virtualized devices instantiated at one or more physical computing devices at a single physical location or distributed at multiple physical locations. Similarly, data store 124 may represent multiple data stores, each of which may be distributed across multiple physical computing devices.

In some embodiments, certain components of automated testing platform 120 may be hosted or otherwise provided by separate cloud computing providers such as Amazon Web Services (AWS)™ or Microsoft Azure™. For example, AWS provides cloud-based computing capabilities (e.g., EC2 virtual servers), cloud-based data storage (e.g., S3 storage buckets), cloud-based database management (e.g., DynamoDB™), cloud-based machine-learning services (e.g., SageMaker™), and various other services. Other cloud computing providers provide similar services and/or other cloud-computing services not listed. In some embodiments, the components of automated testing platform 120 may include a combination of components managed and operated by a provider of the automated testing platform 120 (e.g., an internal physical server computer) as well as other components managed and operated by a separate cloud computing provider such as AWS™.

The automated testing platform 120 can be implemented to perform automated testing of a target application 132. The target application 132 may include any type of application (or app) configured to run on personal computers (e.g., for Windows™, MacOS™, etc.), applications configured to run on mobile devices (e.g., for Apple™ iOS, Android™, etc.), web applications, websites, etc. In some embodiments, the automated testing platform 120 is configured to perform automated testing of various GUI functionality associated with a target application 132. For example, in the case of a website with interactive elements, automated testing platform 120 may be configured to test the interactive elements associated with the website as presented via one or more different web browser applications.

The target application 132 can be hosted by a network system connected to network 110 such as an application server 130. In the case of a website, application server 130 may be referred to as a web server. In any case, as with server 122, application server 130 may represent a single physical computing device or may represent multiple physical and/or virtual computing devices at a single physical location or distributed at multiple physical locations.

Various end users 142 can access the functionality of the target application 132, for example, by communicating with applications server 130 over network 110 using a network-connected end user device 140. An end user device 140 may represent a desktop computer, a laptop computer, a server computer, a smartphone (e.g., Apple iPhone™), a tablet computer (e.g., Apple iPad™), a wearable device (e.g., Apple Watch™), an augmented reality (AR) device (e.g. Microsoft Hololens™), a virtual reality (VR) device (e.g., Oculus Rift™), an internet-of-things (IOT) device, or any other type of computing device capable of applying the functionality of target application 132. In some embodiments, end users 142 may interact with the target application via a GUI presented at the end user device 140. In some embodiments, the GUI through which the user 142 interacts with the target application 132 may be associated with the target application 132 itself or may be associated with a related application such as a web browser in the case of a website. In some embodiments, interaction by the end user 142 with the target application 132 may include downloading the target application 132 (or certain portions thereof) to the end user device 140.

A developer user 152 associated with the target application 132 (e.g., a developer of the target application 132) can utilize the functionality provided by automated testing platform 120 to perform automated testing of the target application 132 during development and/or after the target application has entered production. To do so, developer user 152 can utilize interface 153 presented at a developer user device 150, for example, to configure an automated test, initiate the automated test, and view results of the automated test. Interface 153 may include a GUI configured to receive user inputs and present visual outputs. The interface 153 may be accessible via a web browser, desktop application, mobile application, or over-the-top (OTT) application, or any other type of application at developer user device 150. Similar to end user devices 140, developer user device 150 may represent a desktop computer, a laptop computer, a server computer, a smartphone, a tablet computer, a wearable device, an AR device, a VR device, or any other type of computing device capable of presenting interface 153, and/or communicating over network 110.

Although the networked computing environment 100 depicted in FIG. 1 shows only one developer user 152 and one target application 132 for testing, in some embodiments, multiple different developer users associated with multiple different target applications may access the automated testing functionality of automated testing platform 120. For example, the various functionalities associated with automated testing platform 120 may be provided to various application developers as a service to test their respective applications during development and/or after entering production. In some embodiments, automated testing services may be provided by the automated testing platform 120 for a one-time and/or subscription fee. Developer users signing up for the automated testing services may access such services by connecting, for example, via network 110 to the automated testing platform 120. In other words, in some embodiments, automated testing services can be provided to the developer users without downloading or installing any software to a computing system associated with or managed by the respective developer users.

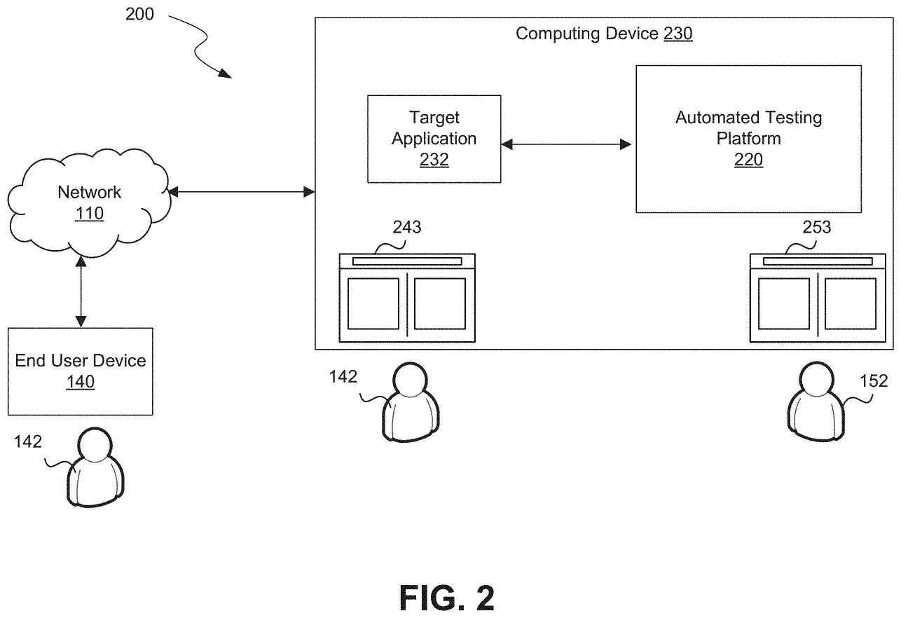

FIG. 1 depicts an automated testing platform 120 in the context of a networked computing environment 100; however, the introduced technique is not limited to such a context. In some embodiments, one or more components of automated testing platform 120 may be instantiated locally at a computing device that hosts the target application. For example, FIG. 2 depicts an alternative computing environment 200 in which the introduced technique can be implemented. As shown in FIG. 2, a computing device 230 hosts both the target application 232 (analogous to target application 132) as well as the automated testing platform 220. In this example, automated testing platform 220 may represent software installed at computing device 220. In other words, target application and automated testing platform 220 may share the common computing hardware (e.g., memory, processor, storage, etc.) of computing device 230 although they may be implemented in different virtual machines instantiated at computing device 230. End users 142 may access the functionally of target application 232 locally, for example, via interface 243 and/or remotely via network 110 using a network-connected end user device 140. Further, the developer user 152 may interact with the automated testing platform 220 via interface 253 (analogous to interface 153), for example, to configure an automated test, initiate the automated test, and view results of the automated test.

One or more of the devices and systems described with respect to FIGS. 1-2 (e.g., automated testing platform 120, application server 130, end user devices 140, developer user device 150, computing device 230, etc.) may be implemented as computer processing systems. As used herein, a “computer processing system” may include one or more processors (e.g., central processing units (CPU), graphical processing units (GPU), etc.) that are coupled to one or more memory (e.g., volatile and/or non-volatile) that store instructions that can be executed using the one or more processors to perform operations associated with the introduced technique. A computer processing system may further include one or more storage media such as hard disk drives (HDD), solid state drives (SSD), and/or removable storage media (e.g., Compact Disc Read-Only Memory (CD-ROM)). The memory and storage media may be collectively referred to herein as non-transitory computer-readable (or machine-readable) media. Such non-transitory computer-readable media may include single devices or may include system of multiple devices at different physical locations (e.g., distributed databases).

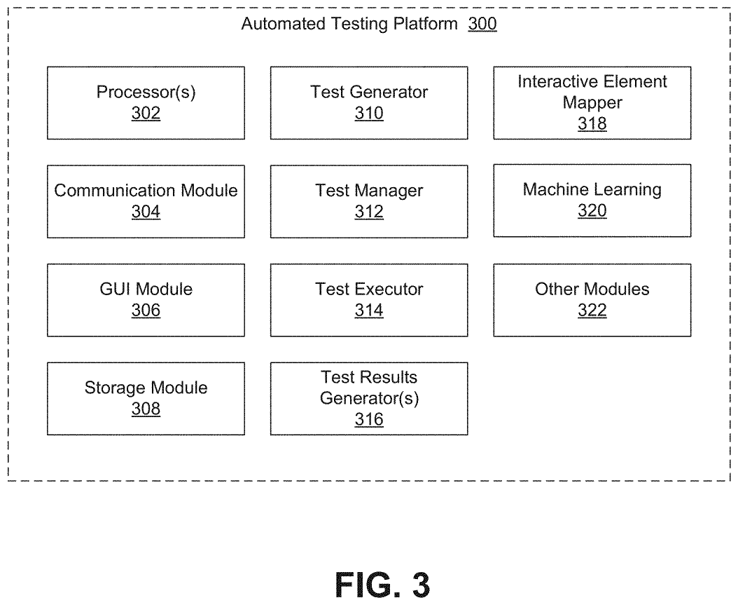

FIG. 3 is a block diagram illustrating a high-level architecture of an example automated testing platform 300. Example automated testing platform 300 may be the same or similar to automated testing platform 120 depicted in FIG. 1 and automated testing platform 220 depicted in FIG. 2. As shown in FIG. 3, automated testing platform 300 includes one or more processors 302, a communication module 304, a GUI module 306, a storage module 308, a test generator module 310, a test manager module 312, a test executor module 314, a test results generator module 316, an interactive element mapper module 318, a machine learning module 320, and may include other modules 322.

Each of the modules of example automated testing platform 300 may be implemented in software, hardware, or any combination thereof. In some embodiments, a single storage module 308 includes multiple computer programs for performing different operations (e.g., metadata extraction, image processing, digital feature analysis), while in other embodiments each computer program is hosted within a separate storage module. Embodiments of the automated testing platform 300 may include some or all of these components, as well as other components not shown here.

The processor(s) 302 can execute modules from instructions stored in the storage module(s) 308, which can be any device or mechanism capable of storing information. For example, the processor(s) 302 may execute the GUI module 306, a test generator module 310, a test manager module 312, a test executor module 314, etc.

The communication module 304 can manage communications between various components of the automated testing platform 300. The communication module 304 can also manage communications between a computing device on which the automated testing platform 300 (or a portion thereof) resides and another computing device.

For example, the automated testing platform 300 may reside one or more network-connected server devices. In such embodiments, the communication module 304 can facilitate communication between the one or more network-connected server devices associated with the platform as well as communications with other computing devices such as an application server 130 that hosts the target application 132. The communication module 304 may facilitate communication with various system components through the use of one or more application programming interfaces (APIs).

The GUI module 306 can generate the interface(s) through which an individual (e.g., a developer user 152) can interact with the automated testing platform 300. For example, GUI module 306 may cause display of an interface 153 at computing device 150 associated with the developer user 152.

The storage module 308 may include various facilities for storing data such as data store 124 as well as memory for storing the instructions for executing the one or more modules depicted in FIG. 3.

The test generator module 310 can generate automated tests to test the functionality of a target application 132. For example, in some embodiments, the test generator module 310 can generate one or more testing scenarios for testing an application. A testing scenario represents a plan to check the interactive functionality of the target application, for example, by filling forms, clicking buttons, viewing screen changes, and otherwise interacting with the various GUI elements of an application. A generated testing scenario plan may define a sequence of steps of interaction with the target application 132. As an illustrative example, a generated testing scenario may include 1) start the target application 132; 2) wait, 3) crawl the first page in the GUI of the target application 132 to identify one or more interactive elements, 4) interact with each of the identified interactive elements (e.g., click buttons, enter data into fields, etc.), and 5) create additional test scenario plans for every combination of interactive elements on the page, etc. In some embodiments, each step in the test scenario is defined as a data object (e.g., a JavaScript™ Object Notation (JSON) object).

In some embodiments, an automated test for a target application 132 can be configured based on inputs from a developer user 152 received via interface 153. For example, the developer user 152 can specify which types of elements to interact with as part of the test, how long a test executor 314 should wait for a reaction after interacting with an element, which areas of the target application 132 to prioritize for testing, etc. In some embodiments, automated tests can be generated based on one or more rules that specify certain sequences of interaction. A directory of rules may be stored in storage module 308. In some embodiments, the rules used to generate tests may be specific to any of an application, an application type (e.g., an Apple™ iOS app), an industry type (e.g., travel app), etc. As will be described in more detail, in some embodiments, automated tests can be generated based on the recorded interaction with the target application 132 by end users 140.

The test manager module 312 may manage various processes for performing an automated test. For example, the test manager may obtain a generated test scenario from storage module 308, identify tasks associated with the test scenario, assign the tasks to one or more test executors 314 to perform the automated test, and direct test results received from the test executors 314 to a test results generator for processing. In some embodiments, the test manager 312 may coordinate tasks to be performed by a single test executor 314. In other embodiments, the test manager 312 may coordinate multiple test executors (in some cases operating in parallel) to perform the automated test.

The test executor module 314 may execute the one or more tasks associated with an automated test of a target application 132. In an example embodiment, the test executor 314 first requests a next task via any type of interface between the test executor 314 and other components of the automated test platform 300. Such an interface may include, for example, one or more APIs. An entity (e.g., the test manager 312) may then obtain the next task in response to the test executor's 314 request and return the task to the test executor 314 via the interface. In response to receiving the task, the test executor 314 starts an emulator, walks through (i.e., crawls) the target application 132 (e.g., by identifying and interacting with a GUI element) and obtains a test result (e.g., screen capture of the GUI of the target application 132). The test executor 314 then sends the obtained result (e.g., the screen capture) via the interface to a storage device (e.g., associated with storage module 308). The test executor 314 can then repeat the process of getting a next task and returning results for the various pages in the GUI of the target application 132 until there are no additional pages left, at which point the test executor 313 may send a message indicating that the task is complete.

The test results generator 316 may receive results from the one or more test executors 314, process the results, and generate an output based on the results for presentation to the developer user 152, for example, via interface 153. As previously mentioned, the results returned by the test executor 314 may include screen captures of the GUI of the target application 132, for example, at each step in the automated test process. The test results generator 316 may process the received screen captures to, for example, organize the captures into logical flows that correspond with user interaction flows, add graphical augmentations to the screen captures such as highlights, etc. The test results generator 316 may further process results from repeated tests to detect issues such as broken GUI elements. For example, by comparing a screen capture from a first automated test to a screen capture from a second automated test, the test results generator may detect that a GUI element is broken or otherwise operating incorrectly.

The interactive element mapper module 318 may identify correspondences between interactive elements (e.g., buttons, pull-down menus, editable text fields, etc.) on various pages of a GUI of the target application 132 and map those correspondences to facilitate an automated testing process. For example, in some embodiments, the interactive element mapper module 318 compares one or more properties associated with various interactive elements identified in a GUI of the target application 132, generates a matrix of similarity values based on the comparisons, and identifies corresponding interactive elements (e.g., the same button on two different pages of the GUI) based on the generated matrix. Such element mapping can then be applied to, for example, detect if an interactive element is missing on a subsequent page, determine when the test executor 314 has returned to a previously accessed page during a testing scenario, etc.

Various components of automated testing platform 300 may apply machine learning techniques in their respective processes. For example, test generator module 310 may apply machine learning when generating a test scenario to apply to a target application 132. As another example, a test executor 314 may apply machine learning to identify elements in a GUI of the target application 132 and may apply machine learning to decide how to interact with such elements. As yet another example, the interactive element mapper module 318 may apply machine learning to detect when certain elements correspond to each other based on a mapping process.

In any case, the machine learning module 322 may facilitate the generation, training, deployment, management and/or evaluation of one or more machine learning models that are applied by the various components of automated testing platform 300. In some embodiments, various machine learning models are generated, trained, and stored in a model repository in storage module 308 to be accessed by other modules. Examples of machine learning algorithms that may be applied by the machine learning models associated with machine learning module 322 include Naïve Bayes classifiers, support vector machines, random forests, artificial neural networks, etc. The specific type of machine learning algorithm applied in any use case will depend on the requirements of the use case.

### Example Automated Testing Process

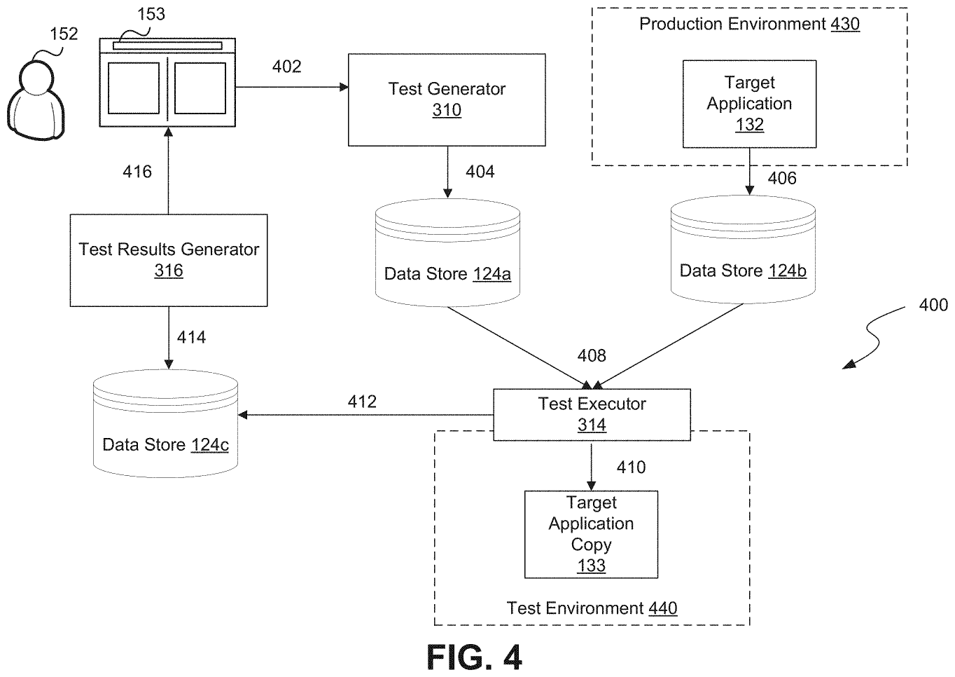

FIG. 4 is an architecture flow diagram that illustrates an example automated testing process. The example process 400 is described with reference to components of an automated testing platform 120, 220, 300 that are described with respect to FIGS. 1-3 (respectively).

Example process 400 begins at operation 402 with a developer user 152 providing inputs, via interface 153, to configure a new automated test of a target application 132. As depicted in FIG. 4, the target application 132 is deployed in a production environment 430 (e.g., hosted by an application server 130) and may be accessible by one or more end users 142. The production environment 430 may represent an environment where the target application 132 is available to the general public or may represent some sort of closed production environment that is only accessible to a select set of end users (e.g., Quality Assurance (QA) testers). In any case, the production environment 430 may include or otherwise mimic the conditions under which the target application 132 with be accessed by an intended set of end users.

The test generator 310 then uses the inputs provided at operation 402 to generate one or more testing scenarios for the target application 132, and at operation 404, the test generator 310 stores test data indicative of the generated testing scenarios in data store 124a. As previously discussed, each testing scenario may define a sequence of tasks with each task represented in a data object (e.g., a JSON object).

At operation 406, application files associated with target application 132 are uploaded from the production environment 430 and stored at data store 124b. The application files uploaded to data store 124b may comprise the entire target application and/or some portion thereof. For example, in the case of a website, the uploaded files may include one or more files in Hypertext Markup Language (HTML) that can then be tested using one or more different browser applications stored in the automated testing platform 120. In some embodiments, a test manger 312 (not shown in FIG. 4) coordinates the uploading of test files from the production environment 430.

At operation 408, a test executor 314 downloads data indicative of a stored testing scenario from data store 124a and the stored application files from data store 124b and at operation 410 initiates testing of a target application copy 133 in a separate test environment 440. The test environment 440 may be part of a virtual machine configured to mimic the computer system or systems hosting the production environment 430. Again, although not depicted in FIG. 4, in some embodiments, a test manager 312 may coordinate the initiation of the test environment 440 and the download of the application files into the test environment 440. In some embodiments, an emulator (e.g., browser emulator, operating system emulator, etc.) is initiated in the test environment 440 to facilitate automated testing of the target application 133.

In some embodiments, the process of testing by the test executor 314 may include obtaining a task from a test manager 312, walking through the application 133 (e.g., by identifying and interacting with UI elements) and obtaining test results such as screen captures of the UI of the application 133 before, during, and/or after interaction with the various UI elements. The test results (e.g., screen captures) obtained by the test executor 314 can then be stored, at operation 412, in data store 124c. This process of storing test results at operation 412 may be performed continually as test results are obtained or at regular or irregular intervals until all the pages in the target application 133 have been tested or the defined task is otherwise complete.

Notably, in some embodiments, the obtained task may only specify a high-level task to be performed by the test executor 314 as opposed to specific instructions on how to perform the task. In such cases, a test executor may apply artificial intelligence techniques to perform a given task. For example, in response to receiving a task to enter a value in a search field, the test executor 314 may, using artificial intelligence processing, crawl the various UI elements associated with a target application 132 to identify a particular UI element that is likely to be associated with a search field. In some embodiments, this may include processing various characteristics associated with a UI element (e.g., type of element (field, button, pull-down menu, etc.), location on a page, element identifier, user-visible label, etc.) using a machine learning model to determine what a particular UI element is.

At operation 414, the test results generator 316 accesses the test results stored in data store 124c for further processing. For example, test results generator 316 may process accessed test results to, for example, organize screen captures into logical flows that correspond with user interaction flows, add graphical augmentations to the screen captures such as highlights, etc. The test results generator 316 may also access test results from a previous test of the target application 132 to compare the new test results to previous test results. For example, by comparing a screen capture from a first automated test to a screen capture from a second automated test, the test results generator 316 may detect that a GUI element associated with target application 132 is broken or otherwise operating incorrectly.

Finally, at operation 416, the test results generator may cause display of a set of processed test results to the developer user 152 via interface 153. Again, the processed test results may include screen captures of the UI of the target application 132 that are organized into logical flows, indicators of UI elements that are broken or otherwise operating incorrectly, etc.

The process depicted in FIG. 4 is an example provided for illustrative purposes and is not to be construed as limiting. Other processes may include more or fewer operations and/or may involve more or fewer components than are depicted in FIG. 4 while remaining within the scope of the present disclosure. For example, although depicted in FIG. 4 as separate entities, data stores 124a-c may be part of an overall system data store (e.g., data store 124 of FIG. 1) and/or may represent more than three separate data storage devices.

### Mapping Interactive Elements in an Application User Interface

In some embodiments, the automated testing platform 120 may need to identify corresponding interactive elements in differing pages of a GUI of the target application 132 being tested. For example, when reproducing a sequence of steps during an automated test, a testing entity (e.g., test executor 314) may need to detect whether an interactive element such as a button is missing. As another example, when performing a sequence of steps during an automated test, the testing entity may need to detect whether it has returned to a previously visited page. One or more of the example operations associated with the mapping of interactive elements are described herein as being performed by an interactive element mapper 318, as described with respect to FIG. 3; however, such operations may be similarly performed by other modules such as the test executor 314.

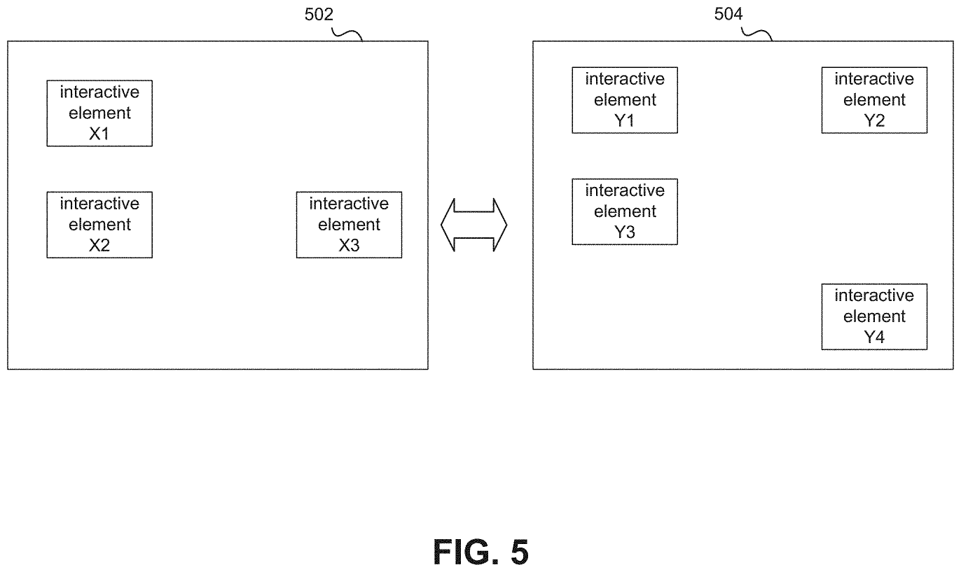

FIG. 5 is a block diagram that illustrates, at a high level, the concept of comparing interactive elements between different pages of a GUI of a target application 132. Specifically, FIG. 5 shows a representation of a first page 502 of a GUI of the target application 132 and a representation of a second page 504 of the GUI of the target application 132. As shown in FIG. 5, the first page 502 includes multiple interactive elements (X1, X2, and X3) and the second page 504 also includes multiple interactive elements (Y1, Y2, Y3, and Y4). In this illustrative example, the first page 502 and second page 504 may represent a sequence of states of the GUI during interaction. For example, in response to interacting with an element (e.g., pressing a button) in the first page 502, the GUI may display the second page 504. Alternatively, the first page 502 and second page 504 may represent different states of a corresponding page in a GUI, for example, as presented in different versions of the target application. For example, the first page 502 may represent a page in a GUI of a first version of the target application 132 while the second page 504 may represent that same page in GUI in a second version of the target application 132.

In any case, the introduced technique can be applied to compare the interactive elements occurring in the first page 502 (i.e., elements X1, X2, and X3) to the interactive elements occurring in the second page 504 (i.e., elements Y1, Y2, Y3, and Y4) to determine whether any of the elements correspond to each other. For example, in an illustrative scenario involving a travel application, one of the elements in the first page 502 may be a “search” button having the functionality to initiate a search (e.g., for flights) in response to detected user interaction. An interactive element having the same or similar functionality (i.e., another search button) may also appear in the second page 504. The two elements would therefore correspond with each other even if there are some differences between the elements such as differences in visual presentation to the user, different locations on the page, etc. However, such a correspondence may not be readily apparent to an entity performing the automated test (e.g., test executor 314). For example, as previously discussed, a test executor 314 may perform certain operations of an automated test that include crawling a target application 132 and identifying various interactive elements of a GUI of the target application as part of the crawling. In other words, as part of the crawling, the test executor 314 will determine that the first page 502 includes elements X1, X2, and X3 and that the second page 504 includes elements Y1, Y2, Y3, and Y4. Without additional analysis according to the introduced technique, the test executor 314 may not “know” that one interactive element in the first page 502 corresponds to another interactive element in the second page 504.

To identify and map such correspondences between elements, the introduced technique can include identifying various properties associated with identified interactive elements and comparing such properties between interactive elements in different pages. Properties of an interactive element can include, for example, a path associated with the element, a path group associated with the element, an identifier associated with the element, a name of the element, a label associated with the element, a hint associated with the element, text associated with the element, a class associated with the element, an index of the element, a digital asset (e.g., an image) associated with the element, a position of the element on a page in the GUI, a color of the element, etc. Some properties may be specific to certain types of interactive elements. For example, if an interactive element is a listing of items, a property of that interactive element may include a quantity of items included in the listing. These are just examples of various properties that can be identified and analyzed to identify and map correspondences between elements. A person having ordinary skill in the art will recognize that other types of properties can similarly be analyzed without departing from the scope of the introduced technique.

The one or more properties of each interactive element can then be compared to generate similarity values that are indicative of a level of similarity between pairs of interactive elements occurring on different pages in the GUI. For example, for each element Xi in a first page 502 and each element Yi in the second page, a similarity value is generated that is indicative of a level of similarity between the element Xi and element Yi. In some embodiment, the similarity value is generated based on a sum of the properties that are the same (or that satisfy some similarity criterion) between elements Xi and Yi. For example, if interactive element X1 and Y1 are both labeled as “search,” then a similarity value of 1 may be generated that is associated with the pair of elements X1 and Y1. If the pair of elements X1 and Y1 are also located at a same (or similar) position on the pages 502 and 504, the similarity value may be incremented to 2.

In some embodiments, each of the one or more properties used to compare interactive elements may be associated with a particular weight value. For example, the following table shows some example weights that can be applied to various properties of the interactive elements:

TABLE 1

| Property | Weight |
|---|---|
| Path | 30.0 |
| Identifier | 99.0 |
| Class | 70.0 |
| Position on page | 85.0 |
| If a list - number of elements in list | 5.0 |

As shown in Table 1, certain properties may be weighted more heavily than other properties. For example, the identifier property has a weight value of 99.0 while the path property has a weight value of 30.0. This means that two elements sharing the same or similar identifier is more indicative that the two elements correspond with each other than the two elements sharing the same or similar path.

In some embodiments, the weights associated with the various properties are set manually by a user such as an administrator user associated with platform 120 or the developer user 152. For example, a developer user 152 may, using interface 153, provide inputs to set weight values for the various properties. In some embodiments, the weight values may be set automatically, for example, using machine learning techniques. The weight values may remain static until manually adjusted or may dynamically and automatically change over time, for example, using machine learning.

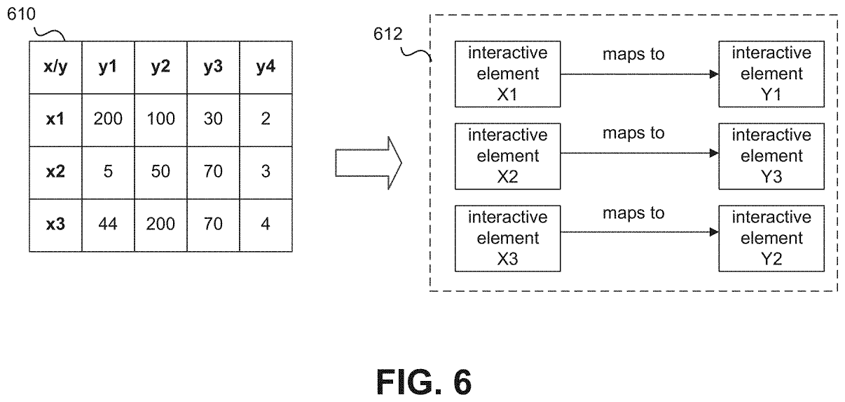

In some embodiments, the similarity values of each element combination Xi and Yi are organized into a matrix to identify correspondences between elements. FIG. 6 shows an example matrix 610 that include multiple similarity values based, for example, on the various interactive elements shown in FIG. 5 (i.e., interactive elements X1, X2, X3 of page 502 and interactive elements Y1, Y2, Y3, Y4 of page 504). For example, a comparison of the one or more properties of elements X1 and Y1 yields a similarity value of 200 while a comparison of the one or more properties of X1 and Y4 yields a similarity value of 2. In some embodiments, each value in the matrix may be stored as a triplet value of the form (xᵢ, yᵢ, wᵢ), wherein xᵢ is an identifier associated with a particular interactive element of the first page 502 of the GUI (i.e., element Xi), yᵢ is an identifier associated with a particular interactive element of the second page 504 of the GUI (i.e., element Yi), and wᵢ is the similarity value generated based on the comparison of properties of element Xi and Yi.

The various similarity values of matrix 610 can then be processed to determine whether a certain element Xi in the first page 502 correspond with a certain element Yi in a second page 504. This determined correspondence can be used to generate an interactive element map 612 that maps corresponding elements. For example, as shown in FIG. 6, based on the similarity values of matrix 610, a system implementing the introduced technique may determine that element X1 maps to element Y1 (similarity value=200), that element X2 maps to element Y3 (similarity value=70), that element X3 maps to element Y2 (similarity value=200), and that none of the elements in the first page 502 map to element Y4 in the second page 504.

The specific manner in which element mappings are determined from a matrix of similarity values can differ in various embodiments. In the example embodiment depicted in FIG. 6, the mapping process may include identifying the maximum similarity value for each interactive element Xi on the first page 502 as compared to other similarity values for that same element. Here, the maximum similarity value for element X1 is 200 which corresponds with element Y1, the maximum similarity value for element X2 is 70 which corresponds with element Y3, and the maximum similarity value for element X3 is 200 which corresponds with element Y2.

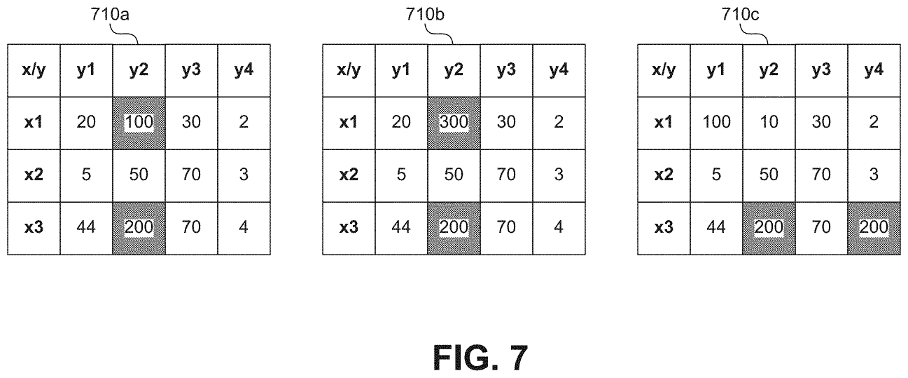

The maximum similarity values may not provide a straight forward mapping solution in all situations. For example, FIG. 7 shows several matrices that present error conditions, from a mapping standpoint. For example, matrix 710a includes a column (Y2) that includes two maximum similarity values (i.e., for rows X1 and X3). As another example, matrix 710b includes a column (Y2) that includes two maximum similarity values (i.e., for rows X1 and X3) that are the same. As another example, matrix 710c includes a row (X3) that includes two maximum similarity values (i.e., for columns Y2 and Y4) that are the same.

As illustrated by the example matrices 710a-c of FIG. 7, simply selecting the maximum similarity values for element combinations may not yield a single mapping solution in all instances. For example, it is not clear from matrix 710b whether interactive element Y2 maps to element X1 or X3. In such situations, an entity performing the interactive element mapper 318 may generate an error.

In some embodiments, when an error condition occurs (e.g., as described with respect to FIG. 7), the automated testing platform 120 may mark one or more of the compared pages as failed. In other words, the automated testing platform 120 may determine based on the multiple correspondences between elements on two pages that something is broken in one of the two pages.

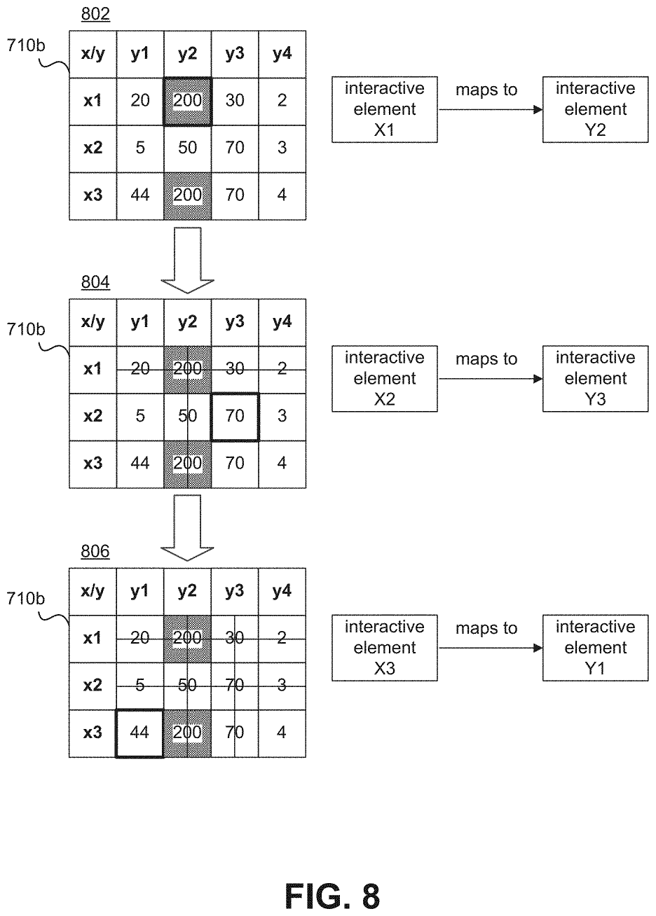

Alternatively, in some embodiments, the interactive element mapper 318 may attempt to identify a mapping solution (optimal or otherwise) even if an error condition is present in the matrix of similarity values. FIG. 8 shows a flow diagram illustrating an example process for identifying element correspondences as part of a mapping process. The example process of FIG. 8 is described with respect to matrix 710b of FIG. 7 to illustrate how an error condition can be handled, in some embodiments.

As shown in FIG. 8, example process begins at operation 802 with identifying the combination with the highest similarity value. In this case, matrix 710b includes two maximum similarity values (for X1, Y2 and X3, Y2) that are equal to each other. In such a situation, one or more rules may be applied to select from the two or more maximum similarity values. For example, as depicted in FIG. 8, operation 802 may start with the first row of similarity values associated with element X1. In other words, the element mapper 318 will map interactive element X1 to interactive element Y2. Other rules may similarly be applied. In some embodiments, the selection may be based on other similarity values in the same row as the maximum similarity value. For example, operation 802 may map element X1 to Y2 because the other similarity values in the X1 row (i.e., 20, 30, and 2) are overall less than the other similarity values in the X3 row (i.e., 44, 70, and 4). This may indicate that the correspondence between element X1 and Y2 is stronger than between X3 and Y2.

In any case, the example process of FIG. 8 continues at operation 804 with removing from consideration any of the similarity values associated with the same row and column as the similarity value selected in the previous operation 802. In other words, since the element mapper 318 has determined that element X1 corresponds to element Y2, any of the similarity values associated with those elements that remain in matrix 710a are disregarded (as indicated by the strike-through lines).

With the similarity values associated with elements X1 and Y2 disregarded, operation 804 further includes identifying the combination with the next highest similarity value. As shown in FIG. 7, the next highest similarity value is 70; however, this similarity value applies to two element combinations (i.e., X2, Y3 and X3, Y3). Again, as in operation 802, one or more rules can be applied to select between the two similarity values. In this example, the element mapper 318 may start with the first valid row and map element X2 to element Y3. As in operation 802, other rules may also be applied for selecting between equal similarity values.

The example process of FIG. 8 continues by repeating the operations 802 and 804 until each element in the first page is mapped to a corresponding element in the second page or until no additional mappings are possible. As shown in FIG. 8, operation 806 includes mapping element X3 to element Y3 (based on the similarity value of 44). Element Y4 does not map to another element.

Operation 806 shows element X3 being mapped to element Y1 based on a similarity value of 44; however, in some embodiments certain similarity criteria may apply before mapping elements. For example, a similarity criterion may specify that in order to identify a correspondence between elements, the similarity value associated with the elements must be above a specified threshold. For example, if the specified threshold is 50, operation 806 would not identify a correspondence between elements X3 and Y1 because the similarity score falls below the threshold. In such a scenario, the element mapper 318 would not map element X3 to any of elements Y1-Y4.

In some embodiments, threshold similarity values may be set manually by a user such as an administrator user associated with platform 120 or the developer user 152. For example, a developer user 152 may, using interface 153, provide inputs to set threshold values for identifying correspondences between elements. In some embodiments, the threshold similarity values may be set automatically, for example, using machine learning techniques. The threshold similarity values may remain static until manually adjusted or may dynamically and automatically change over time, for example, using machine learning.

The process described with respect to FIG. 8 is an example provided for illustrative purposes and is not to be construed as limiting. Other types of processes may be applied to identify a mapping solution given a set of generated similarity values.

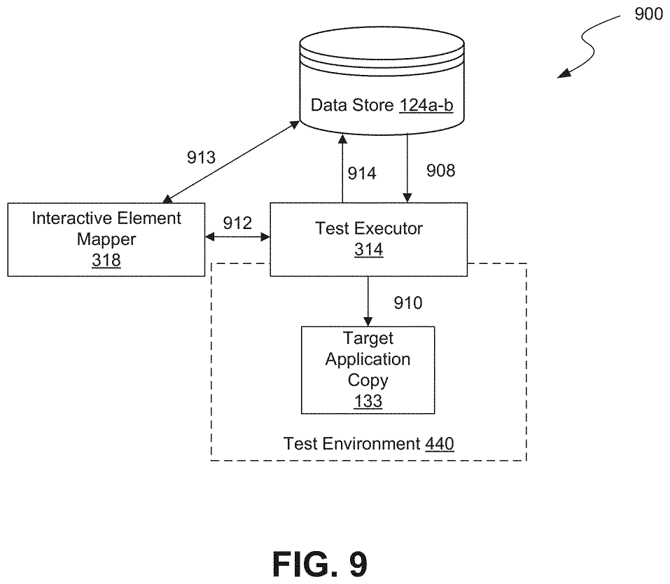

FIG. 9 shows an architecture flow diagram that illustrates an example automated testing process 900 that includes mapping interactive elements in a GUI of a target application. The example process 900 is described with reference to components of an automated testing platform 120, 22, 300 that are described with respect to FIGS. 1-3 (respectively).

Example process 900 begins at operation 908 with a test executor 314 downloading the application files from data store 124a and/or 124b and at operation 910 initiating testing of a target application 133 in test environment 440, for example, as described with respect to operation 408 in example process 400 of FIG. 4.

In some embodiments, the process of testing by the test executor 314 may include obtaining a task from a test manager 312, walking through the application 133 (e.g., by identifying and interacting with GUI elements) and obtaining test results such as captured screenshots of the GUI of the application 133 before, during, and/or after interaction with the various GUI elements.

As part of execution of the automated test, the test executor 314 may coordinate with the interactive element mapper 318 to map interactive elements in a GUI associated with target application 133 according to the introduced technique. In some embodiments, the test executor obtains one or more properties of the various interactive elements in a GUI of the target application 133 and at operation 912 provides those properties to the element mapper 318 for processing. The element mapper 318 processes the properties to identify correspondences between elements and generate element mappings, for example, as previously described with respect to FIGS. 5-8. In other words, the element mapper 318 may generate a matrix of similarity values based on a comparison of properties of the various interactive elements, identify correspondences between interactive elements based on the similarity values, and generate an element map based on the identified correspondences.

In some embodiments, operation 912 may further include the interactive element mapper 318 providing the generated element map back to the test executor 314 to facilitate an automated testing process. For example, using the element map generated by element mapper 318, the test executor 314 may determine whether an interactive element is missing from a page, whether the test executor 314 has returned to previously accessed page, etc.

In some embodiments, the interactive element mapper 318 may, at operation 913, access properties that are stored in data store 124a and/or 124b. For example, the accessed properties may have been stored by a test executor 314 during a previously executed automated test of target application 133. Element properties obtained during a previous automated test can be used by the element mapper 318 to, for example, map interactive elements between different versions of the target application 133.

In any case, the results of the automated test can be stored by the test executor 314 in data store 124 at operation 1014, for example, as described with respect to operation 412 of process 400. In some embodiments, mapping data indicative of the element maps generated by element mapper 318 can also be stored in data store 124a and/or 124b to be accessed by a test executor 314 during a subsequent test of application 133. In some embodiments, the results retuned at operation 914 may include such mapping data.

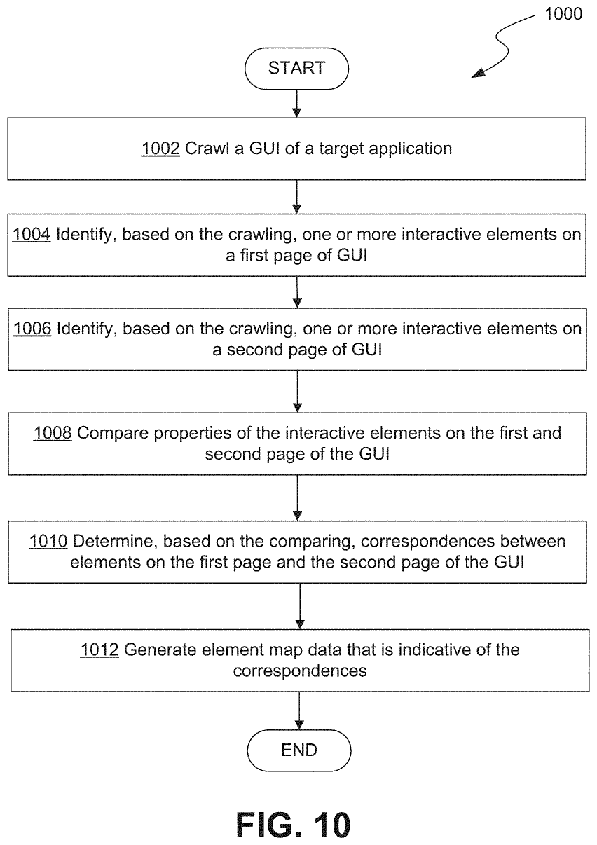

FIG. 10 shows a flow diagram of an example process 1000 for mapping interactive elements in a target application GUI. Example process 1000 can be executed by one or more of the components of an automated testing platform 120 (e.g., element mapper 318). In some embodiments, the example process 1000 depicted in FIG. 10 may be represented in instructions stored in memory that are then executed by a processor. The process 1000 described with respect to FIG. 10 is an example provided for illustrative purposes and is not to be construed as limiting. Other processes may include more or fewer operations than depicted, while remaining within the scope of the present disclosure. Further, the operations depicted in example process 1000 may be performed in a different order than is shown.

Example process 1000 begins at operation 1002 with crawling a GUI of a target application 132, for example, as part of an automated testing process as previously described. As previously discussed, a test executor 314 may crawl a GUI of a target application 132 in response to tasks received from a test manager 312. In some embodiments, crawling the GUI of the target application 132 may include detecting and interacting with one or more interactive elements in the GUI according to an automated testing scenario. The one or more interactive elements may include, for example, buttons, pull-down menus, editable text fields, etc. Interacting with the interactive elements may therefore include, for example, pressing a button, scrolling through a pull-down menu and selecting an item in the pull-down menu, entering data in the editable text field, etc.

Example process 1000 continues at operation 1004 with identifying, based on the crawling, one or more interactive elements on a first page of the GUI, and at operation 1106 with identifying, based on the crawling, one or more interactive elements on a second page of the GUI. As previously discussed, the first page and second page of the GUI may represent a sequence of states of the GUI during interaction. Alternatively, the first page and second page may represent different states of a corresponding page in a GUI, for example, as presented in different versions of the target application 132.

In some embodiments, identifying the interactive elements in the first and second page of the GUI may include detecting, determining, or otherwise obtaining one or more properties of the interactive elements. Properties of an interactive element can include, for example, a path associated with the element, a path group associated with the element, an identifier associated with the element, a name of the element, a label associated with the element, a hint associated with the element, text associated with the element, a class associated with the element, an index of the element, a digital asset (e.g., an image) associated with the element, a position of the element on a page in the GUI, a color of the element, etc.

Example process 1000 continues at operation 1008 with comparing properties of the interactive elements on the first page of the GUI with the properties of the interactive elements on the second page of the GUI. For example, operation 1008 may include comparing a name of a first element on a first page with the name of a second element on the second page of the GUI.

In some embodiments, comparing the properties of interactive elements can include generating a matrix that includes multiple similarity values where each similarity value is indicative of a level of similarity between a particular combination of interactive elements. For example, in the case where the first page has a first plurality of interactive elements and the second page has a second plurality of interactive elements, each similarity value in the matrix is indicative of a level of similarity between a different one of the first plurality of interactive elements and a different one of the second plurality of interactive elements.

In some embodiments, generating a similarity value of the matrix can include comparing multiple properties of a first interactive element in the first page to multiple properties a second interactive element in the second page; identifying, based on the comparing, one or more of the multiple properties that satisfy a similarity criterion; and aggregating property values associated with the one or more properties to generate the similarity value. In some embodiments, the property values aggregated to generate a similarity score can be weighted. In other words, a property value may represent or otherwise incorporate a weight factor that is assigned to a property corresponding to the property value, for example, as illustrated in Table 1.

Example process 1000 continues at operation 1010 with determining, based on the comparing, one or more correspondences between interactive elements on the first page and interactive elements on the second page. In some embodiments, operation 1010 may include at least determining, based on the comparing, that a first interactive element on the first page of the GUI corresponds to a second interactive element on the second page of the GUI. As previously discussed with respect to FIGS. 6-8, the correspondences may be determined based on associated similarity values.

Example process 1000 concludes at operation 1012 with generating element map data indicative of the interactive element correspondences determined at operation 1010. The element map data may be in any form to convey a correspondence between two elements. For example, in some embodiments, element map data may comprise a set of one or more value pairs wherein each value pair includes a first value (e.g., a first identifier) indicative of a first interactive element and a second value (e.g., a second first identifier) indicative of a second interactive element that corresponds to the first interactive element. Other types of data structures can similarly be implemented to generate the element map data. In some embodiments, the element map data generated at operation 1012 can be stored in data store 124 for use by other processes associated with automated testing platform 120.

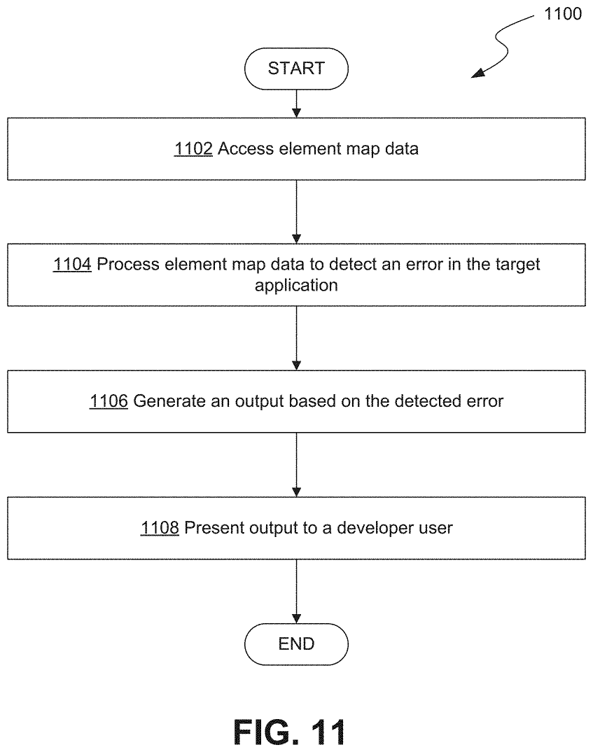

FIG. 11 shows a flow diagram of an example process 1100 for detecting errors in a target application GUI based on element map data. Example process 1100 can be executed by one or more of the components of an automated testing platform 120 (e.g., element mapper 318 and/or test executor 314). In some embodiments, the example process 1100 depicted in FIG. 11 may be represented in instructions stored in memory that are then executed by a processor. The process 1100 described with respect to FIG. 11 is an example provided for illustrative purposes and is not to be construed as limiting. Other processes may include more or fewer operations than depicted, while remaining within the scope of the present disclosure. Further, the operations depicted in example process 1100 may be performed in a different order than is shown.

Example process 1100 begins at operation 1102 with accessing element map data. The element map data may have been generated according to process 1000 of FIG. 10. In some embodiments, the element map data may be accessed from data store 124a and/or 124b. In other embodiments, the element map data may be accessed from a component of platform 120 that generated the data. For example, a test executor 314 may access element map data directly from the interactive element mapper 318.

Example process 1100 continues at operation 1104 with processing the element map data to detect an error in the target application. A detected error may be indicative, for example, of a missing element, an improperly displayed element (e.g., incorrect label, incorrect position on page, etc.) or any other issue associated with the GUI of a target application. For example, in some embodiments, operation 1104 may include processing the element map data to determine that an interactive element is missing on a first page and/or a second page of the GUI of the target application. Similarly, operation 1104 may include processing the element map data to determine that an interactive element is in an incorrect position on a first page and/or a second page of the GUI of the target application.

One or more rules may be applied to determine whether an error or other issue is present based on the element map data. For example, a test executor 314 may be configured to confirm that a subsequently crawled second page of a GUI is error-free as long as one or more of the following example rule conditions are satisfied:
A number of element groups on a first page is less than or equal to a number of element groups on the second page;
At least one element group on the first page exists in the second page;
There are more interactive buttons on the second page than on the first page;
There are more editable fields on the second page than on the first page;
There are more element labels on the second page than on the first page;
There are more interactive lists (e.g., pull-down menus) on the second page than on the first page;
All the interactive buttons on the first page are also on the second page with a similarity value greater than 20;
All the editable fields on the first page are also on the second page with a similarity value greater than 20;
All the element labels on the first page are also on the second page with a similarity value greater than 20; or
All the interactive lists on the first page are also on the second page with a similarity value greater than 20.

The rule conditions recited in the previous paragraph are just examples provided for illustrative purposes. Other types of rules may similarly be applied to detect errors or other issues in the GUI of a target application and/or to confirm the absence of such errors.

Example process 1100 continues at operation 1106 with generating an output based on the error detected at operation 1104. In some embodiments, the output generated at operation 1106 may include a visual output indicative of the detected error. For example, the visual output may include the screenshot along with a visual augmentation (e.g., an overlay) in a region of the screenshot corresponding to a portion of the GUI of the target application with the detected error. For example, if the error is missing button in the GUI, the visual output may include a screenshot of a page of the GUI where the button should be along with a visual augmentation such as a highlighted or otherwise emphasized border around a portion of the GUI where the button should be. In some embodiments, the output may include information about the detected error such as a description of the error, an identifier associated with the interactive element causing the error, recommended solutions to fix the error, a link to the actual page in the target application that includes the error, etc.

Example process 1100 concludes at operation 1108 with presenting the output generated at operation 1106 to a developer user 152, for example, via interface 153.

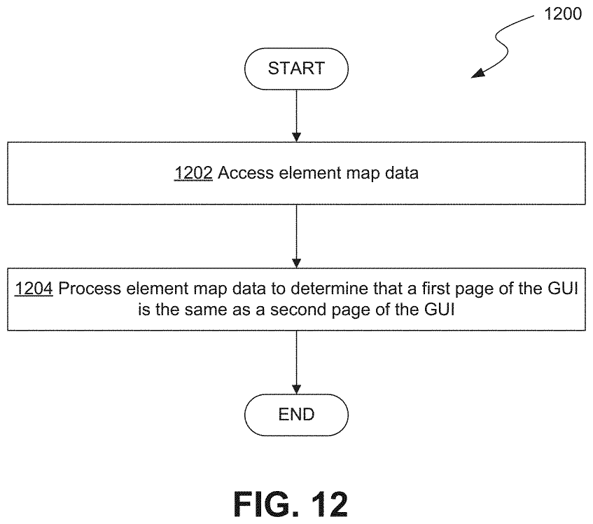

FIG. 12 shows a flow diagram of an example process 1200 for determining that a previously accessed first page of a GUI is the same as a subsequently accessed second page of the GUI based on element map data. Example process 1200 can be executed by one or more of the components of an automated testing platform 120 (e.g., element mapper 318 and/or test executor 314). In some embodiments, the example process 1200 depicted in FIG. 12 may be represented in instructions stored in memory that are then executed by a processor. The process 1200 described with respect to FIG. 12 is an example provided for illustrative purposes and is not to be construed as limiting. Other processes may include more or fewer operations than depicted, while remaining within the scope of the present disclosure. Further, the operations depicted in example process 1200 may be performed in a different order than is shown.

Example process 1200 begins at operation 1202 with accessing element map data, for example, as described with respect to operation 1102 of example process 1100.

Example process 1200 continues at operation 1204 with processing the accessed element map data to determine if a subsequently accessed second page of a GUI of the target application is the same as a previously accessed first page of the GUI. In some embodiments, a test executor 314 may rely on such a determination to detect when it has returned to a previously accessed page in the GUI while crawling the GUI during an automated test of the target application.

One or more rules may be applied to determine whether a subsequently accessed second page of a GUI is the same as a previously accessed first page of the GUI. For example, a test executor 314 may be configured to confirm that it has returned to a previously accessed page in the GUI when one or more of the following example rule conditions are satisfied:
There are exactly the same groups of interactive elements on the second page as on the first page;
There are exactly the same number of interactive buttons in each group on the second page and on the first page;
There are exactly the same number of editable fields in each group on the second page and on the first page;
There are exactly the same number of interactive lists (e.g., pull-down menus) in each group on the second page and on the first page;
All interactive buttons on the first page correspond to a different one of the interactive buttons on the second page with a similarity value greater than 20;
All editable fields on the first page correspond to a different one of the editable fields on the second page with a similarity value greater than 20; or
All interactive lists on the first page correspond to a different one of the interactive lists on the second page with a similarity value greater than 20.

The rule conditions recited in the previous paragraph are just examples provided for illustrative purposes. Other types of rules may similarly be applied to determine whether a previously accessed first page of a GUI is the same as a subsequently accessed second page of the GUI based on element map data.

Although not depicted in the flow chart of FIG. 12, the determination at operation 1204 can be utilized to inform certain processes of the automated testing platform 120. For example, in some embodiments, in response to determining at operation 1204 that it has returned to a previously accessed page of a GUI, the test executor 314 may determine that it has competed a cycle in a testing scenario and terminate the session. Conversely, in response to determining at operation 1204 that a subsequently accessed second page is different (even if slightly) than a previously accessed page, a test executor 314 may identify, based on the element map data, that the difference is due to a new interactive element on the subsequently accessed second page of the GUI. Such a new element may represent a newly discovered functionality in the GUI. Accordingly, the test executor 314 may continue the session to test the functionality of the newly discovered interactive element.

### Example Graphical User Interface

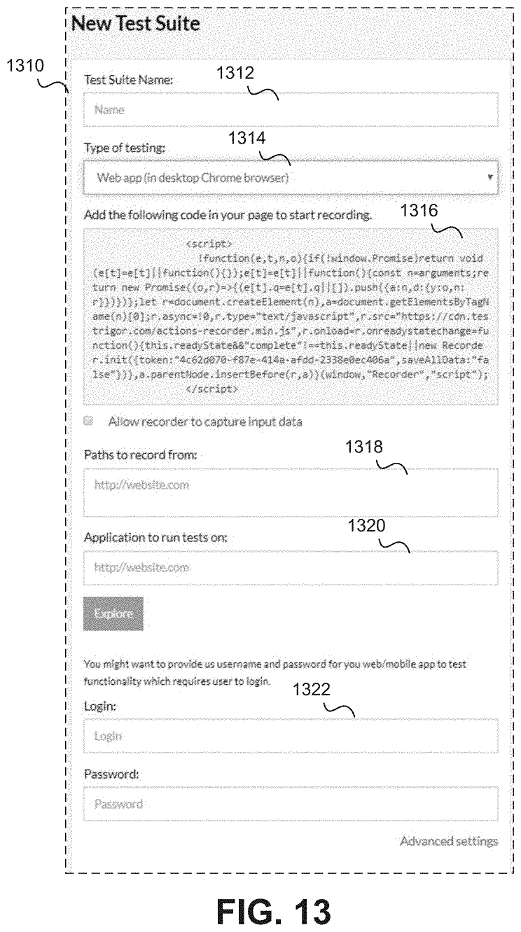

FIGS. 13-21 show a series of screens associated with an example developer GUI associated with automated testing platform 120. In other words, the example developer GUI depicted in FIGS. 13-21 may correspond with the interface 153 described with respect to FIG. 1 and may be utilized by a developer user 152 to perform automated testing of a target application 132. Accordingly, the developer GUI depicted in FIGS. 13-21 may be presented via a display associated with a developer user computing device 150. Note that the included screen captures depicted in FIGS. 13-21 are provided for illustrative purposes to show certain example features of a developer GUI associated with automated testing platform 120 and are not intended to be limiting. Some embodiments may include fewer or more user interaction features than are described with respect to FIGS. 13-21 while remaining within the scope of the introduced technique.

FIG. 13 shows an example screen 1310 of the example developer GUI that may be presented to a developer user 152 when setting up a new automated test. For example, in response to logging in to, or otherwise accessing, automated testing platform 120, a developer user 152 is presented with screen 1310 which includes a prompt to add a new application for testing. The example prompt depicted in screen 1310 includes an editable field 1312 to input a test name and an interactive element 1314 through which a developer user 152 can specify the type of application to be tested. For example, the interactive element 1314 is depicted in FIG. 13 in the form of a pull-down menu that allows the developer user 152 to select from multiple defined application types such as a website (in a desktop version of the Chrome™ browser), a website (in an Android™ version of the Chrome™ browser), an Android™ application, and an Apple™ iOS application. These are just example application types shown for illustrative purposes. Other application types may similarly be included in the prompt associated with screen 1310.

Example screen 1310 also includes a text-based script 1316 that the developer user can copy and place into the code of their application (e.g., website) to facilitate recording user interaction with the application. In some embodiments, such as script is provided when the developer user 152 selects, via element 1314, a website as the application type. Other mechanisms for facilitating recording user interaction may be provided for other application types. For example, if the developer user 152 selects an iOS application as the application type a different type of mechanism such as a link to download a recorder library may be provided to facilitate recording user interactions.

Example screen 1310 also include interactive elements through which a user can specify the paths from which to record user interactions and the application to be tested. For example, interactive element 1318 is an editable text field through which the developer user 152 can input a uniform resource locator (URL) associated with a website to specify a path from which to record user interaction data. Similarly, interactive element 1320 is an editable text field through which the developer user 152 can input a URL of the website to be tests. In the example depicted in FIG. 13, both URLs are the same; however, this may not be the case in all scenarios. Further, if the application is not a website (e.g., an iOS application) elements 1318 and/or 1320 may be replaced with a different UI element that enables the developer user 152 to upload a copy of the application, input a link to download the application, or otherwise enable access to the application.

In some cases, the target application 132 may be associated with some type of login or other authentication protection. In such cases, the developer GUI may prompt the developer user 152 to input necessary authentication information such as HTTP authentication login and password, application login and password, etc. For example, element 1322 in screen 1310 prompts the developer user 152 to input login and password information for the website.

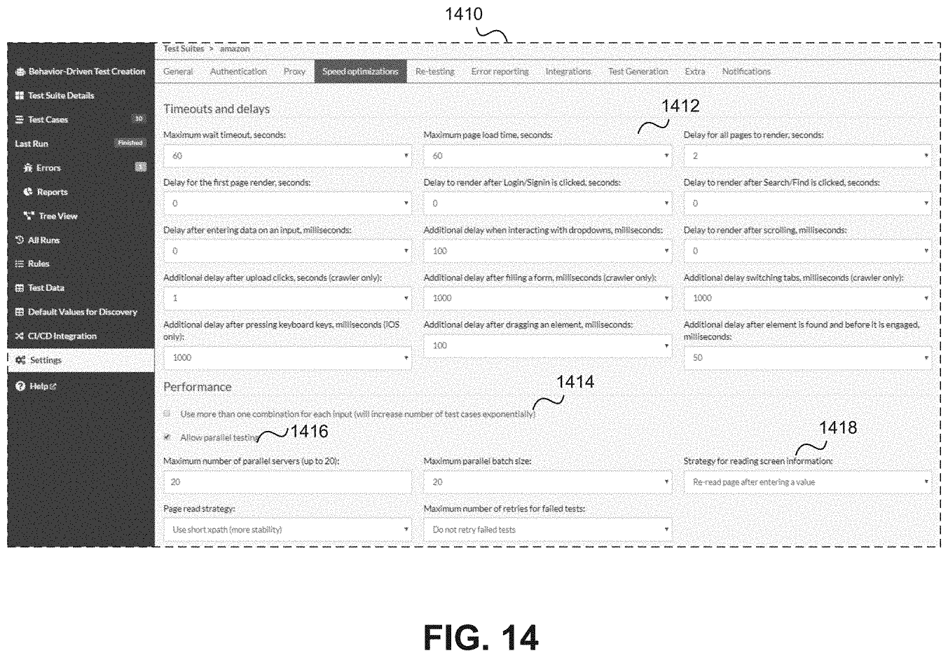

In some embodiments, the developer GUI may present options to the developer user 152 to specifically configure various characteristics of an automated testing process. FIG. 14 shows an example screen for configuring an automated test. Specifically, FIG. 14 shows a screen 1410 of an example developer GUI that includes various interactive elements through which a developer user 152 can set parameters to optimize the speed of performing an automated test. For example, screen 1401 includes various interactive elements 1412 (e.g., in the form of pull-down menus) through which a developer user 152 can set values for various latency-related parameters such as maximum wait timeout, maximum page load time, and delay for page to render. Maximum wait timeout specifies how long the automated testing platform 120 will wait for a server to respond to a page request. Lower numbers will result in a faster test, but larger numbers will be more tolerant of a slow network and/or a busy server. Maximum page load time specifies how long the automated testing platform 120 will wait for a server to send a requested page. Again, lower numbers will result in a faster test, but larger numbers will be more tolerant of a slow network and/or a busy server. Delay for page to render specifies how long the automated testing platform 120 will wait for a given page to render. Lower numbers will result in a faster test, but larger numbers will be more tolerant of larger, more complex pages or pages that are rendered by JavaScript™ in the browser. These are just example latency-related parameters and as depicted in FIG. 14, the screen may include options to set values for other latency related parameters.

Screen 1410 also includes interactive elements through which a developer user 152 can specify how thoroughly the target application is explored during automated testing. For example, by selecting element 1414 (depicted as a toggle button), the developer user 152 can instruct the automated testing platform 120 to perform a more thorough automated test that involves performing more than one testing scenario for each input. As noted, this will tend to increase the number of testing scenarios exponentially, which will result in a more thorough test of the interactive features of the target application 132 although such a test will be slower and more computationally expensive. Other interactive elements may prompt the developer user 152 to, for example, enable the use of parallel testing of scenarios (button 1416) to reduce the time needed to complete testing. Other interactive elements may prompt the developer user 152 to, for example, specify a strategy for reading screen information (pull-down menu 1418). For example, pull-down menu 1418 is depicted as set to re-read a page after entering a value. This setting may slow down testing, but may catch issues that would otherwise be missed if a given page is not re-read after inputting a value. These are just some example configurable parameters that can be set by the developer user via the GUI to configure and automated test based on recorded user interaction with a target application.

Once the developer user 152 has finished configuring the various parameters associated with the automated testing process, an automated test is generated and performed on the target application 132. For example, as part of the automated testing process, one or more test executors 314 will crawl the target application 132 to discover and interact with various interactive elements (e.g., clicking buttons, clicking links, clicking pull-down menus, filling out forms, etc.) and will obtain results (e.g., screen captures) based on the testing.

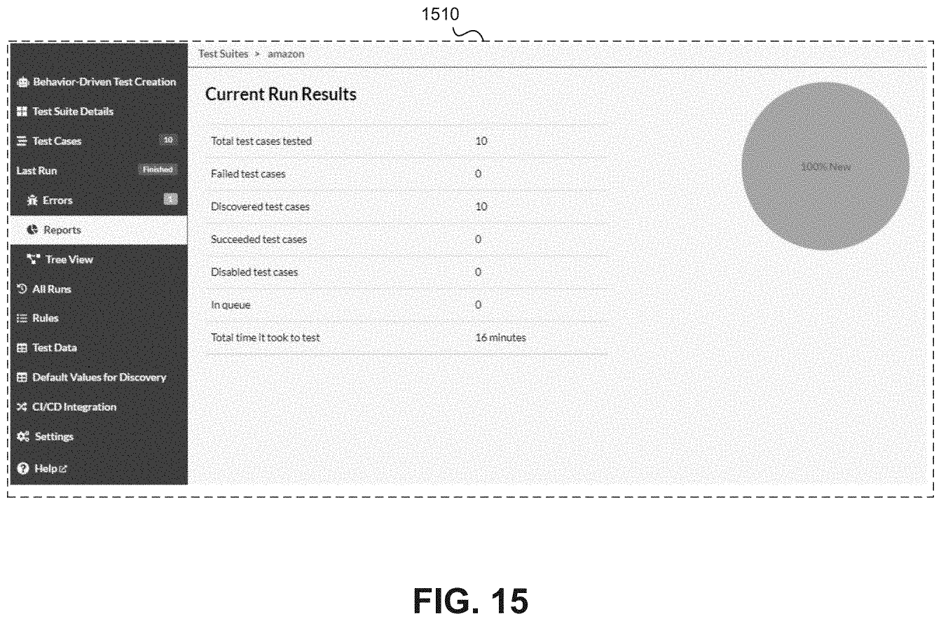

In some embodiments, once the automated test is complete, a summary of the automated test is provided, for example, as depicted in screen 1510 of FIG. 15. As shown in FIG. 15, the summary of an example automated test may provide various aggregate test result data such as total number of test scenarios performed, total number of failed test scenarios, total number of discovered test scenarios, total number of unchanged test scenarios (e.g., between different versions of the target application 132), total number of disabled test scenarios, total number of test scenarios to be retested, and total time to perform the overall automated test. These are just some illustrative examples of the type of information that can be provided in a test summary. Other types of information can similarly be presented while remaining within the scope of the introduced technique.

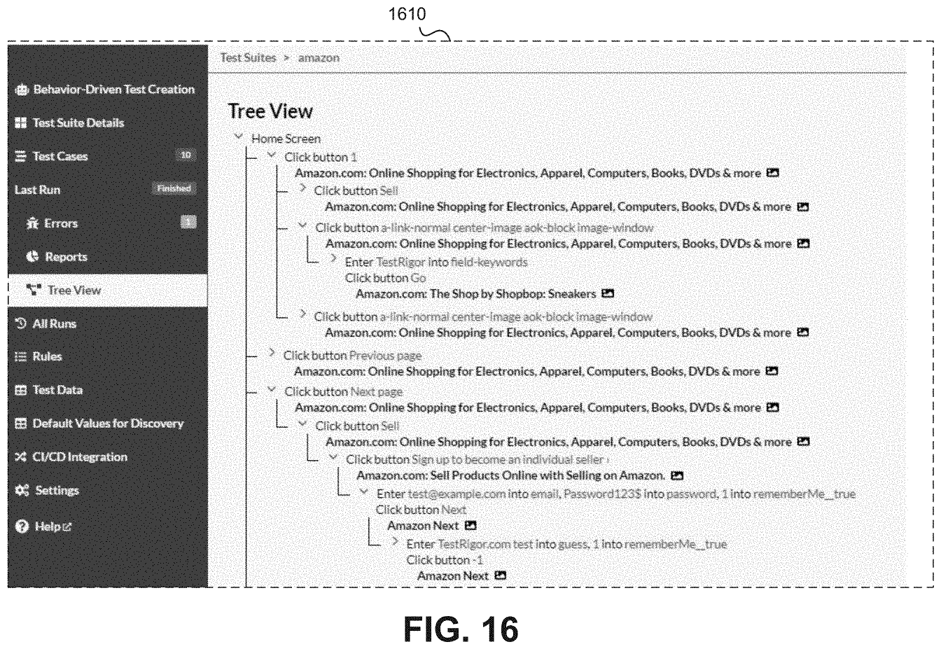

In some embodiments, tree view summary of the automated test can be displayed in the GUI. FIG. 16 shows a screen 1610 of an example developer GUI that includes a tree view summary of the various steps performed as part of an automated test. As shown in screen 1610, various steps performed by a test executor are listed (e.g., click button, enter value, etc.). The various steps are arranged as tree diagram based on branching interaction paths. For example, in the scenario depicted in screen 1610, each interaction path starts at a home screen of the target website and proceeds along different branches from that home screen. In some embodiments, the developer user can interact with the tree view summary to collapse and/or expand certain branches to facilitate navigation of the diagram.

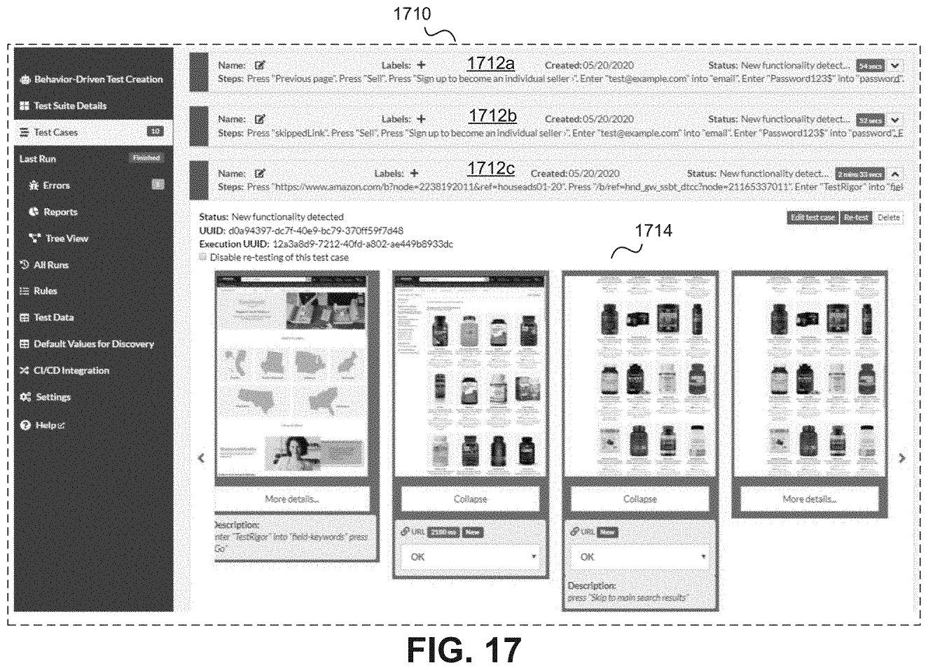

In some embodiments, results of the automated test are presented in the developer GUI. FIG. 17 shows a screen 1710 of an example developer GUI that includes results from various test scenarios performed as part of an automated test of a target application (in this example a website). As shown in FIG. 17, screen 1710 includes interactive elements 1712a-c corresponding to various test scenarios performed as part of an automated test of a target website. The interactive elements 1712a-c include information regarding the corresponding test scenario such as a name of the test scenario, the steps involved in the test scenario (e.g., press button, enter value, etc.), a date the test scenario was created, a status of the test scenario, and duration of the test scenario.

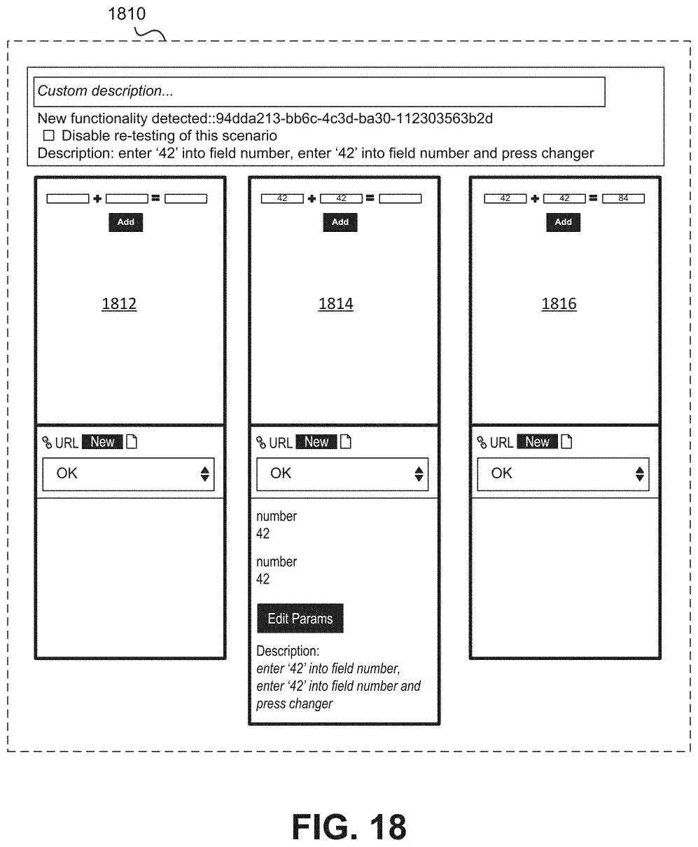

The interactive elements 1712a-c can be expanded to display results associated with each test scenario. For example, in response to detecting a user interaction, interactive element 1712c may dynamically expand to display results of the test scenario in the form of screen captures 1714 of the target application taken by the test executor during the various steps associated with the test scenario, as depicted in FIG. 17. Additional details on how test results can be presented in a developer GUI are described with respect to FIGS. 18-21.

FIG. 18 shows a screen 1810 of an example developer GUI that includes a sequence of screen captures depicting an example test scenario performed during the automated test of a target application 132 (in this case a calculator app). The sequence of screen captures depicted in screen 1810 may be similar to the sequence of screen captures 1714 depicted in screen 1710. Specifically, screen 1810 depicts a sequence of screenshots of the target application 132 during a test of a specific functionality an end user 142 may take while interacting with the target application 132. In this case, the interaction is entering a number into an editable field and pressing an “add” button. Screen capture 1812 shows the GUI of the target application 132 in a first state prior to entering the number, screen capture 1814 shows the GUI of the target application 132 in a second state after entering the number (“42”) but prior to pressing the “add” button, and screen capture 1816 shows the GUI of the target application 132 in a third state after pressing the “add” button. The example test scenario illustrated in the sequence of screen captures shown in FIG. 18 is relatively simple and is provided for illustrative purposes. An actual application may have many possible test scenarios involving more complicated sequences of interaction.

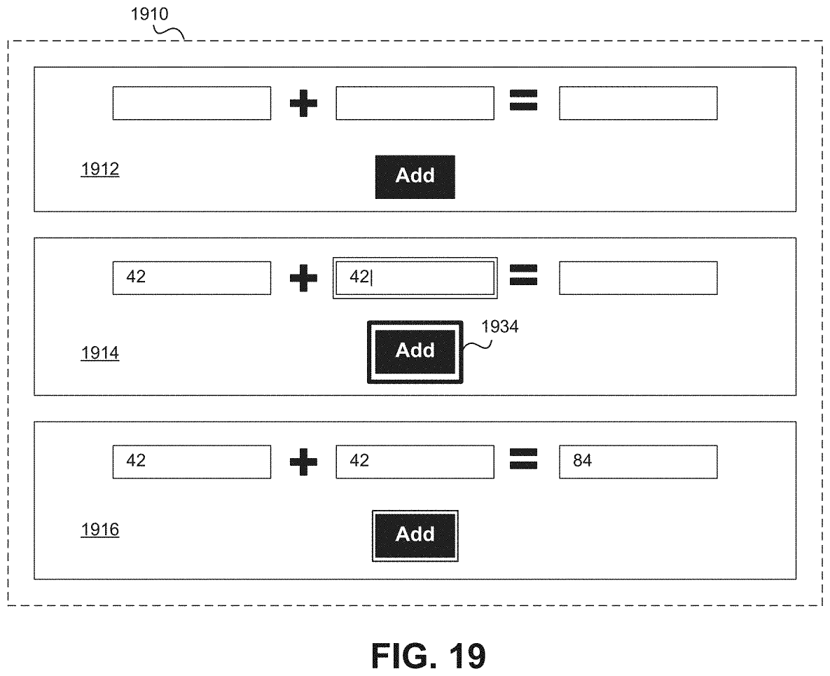

In some embodiments, the developer GUI may enable the developer user 152 to zoom in on the screen captures to view how the GUI of the target application 132 responded to various interactions. FIG. 19 shows an example screen 1910 of the developer GUI that shows a zoomed in portion of each of the respective screen captures 1812, 1814, and 1816 of FIG. 18. Specifically, screen capture 1912 shows a zoomed in portion of screen capture 1812 depicting the GUI of the target application 132 in the first state (i.e., before any interaction). Screen capture 1914 shows a zoomed in portion of screen capture 1814 depicting the GUI of the target application 132 in the second state (i.e., after entering the number 42 but before pressing the “add” button). Screen capture 1916 shows a zoomed in portion of screen capture 1816 depicting the GUI of the target application 132 in the third state (i.e., after pressing the “add” button).

In some embodiments, the screen captures displayed via the developer GUI may include visual augmentations that provide additional information to the developer user 152 reviewing the results. For example, as shown in FIG. 19, a visual augmentation 1934 is added to indicate the interaction leading to the next screen capture. Specifically, the visual augmentation 1934 includes a highlight that surrounds a region of the GUI of the target application 132 corresponding to the “add” button. This visual augmentation 1934 indicates to the developer user 152 that the “add” button is pressed resulting in the next screen capture 1916. This is just an example of a visual augmentation that can be added to screen captures to provide additional contextual information. Other types of visual augmentation can similarly be implemented. In some embodiments, the added visual augmentation can be color coded to indicate different types of interaction (e.g., button press vs. data entry). In some embodiments, visual augmentations may be animated to indicate different types of interaction (e.g., a gradually widening highlight indicating a button press).

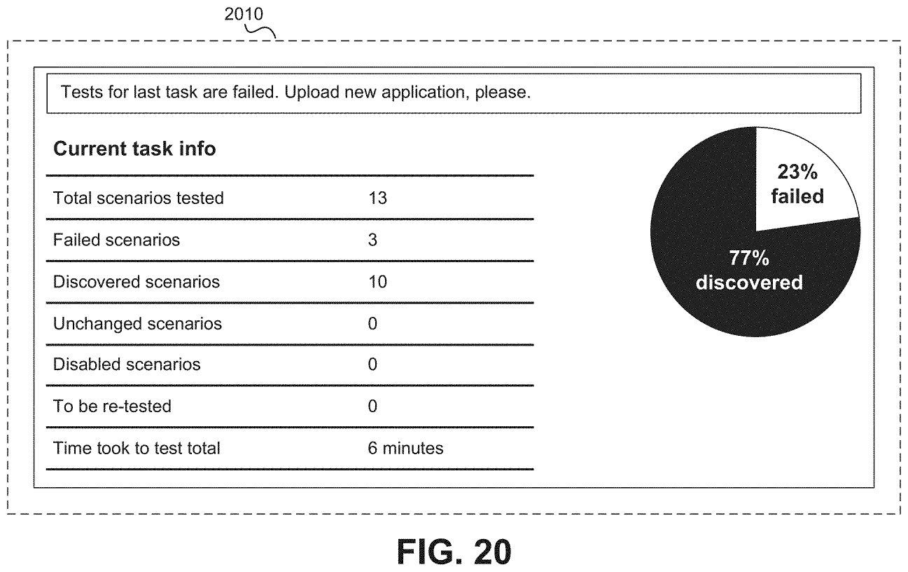

As previously discussed, automated tests can be performed again, for example, after updating the target application 132 to a newer version. FIG. 20 includes a screen 2010 showing an updated test summary for the target application 132 resulting from a retest. In this case, the retest has resulted in several failed scenarios due, for example, to a change in the target application 132. In this example, the test summary indicates that 23% of the testing scenarios resulted in a failure.

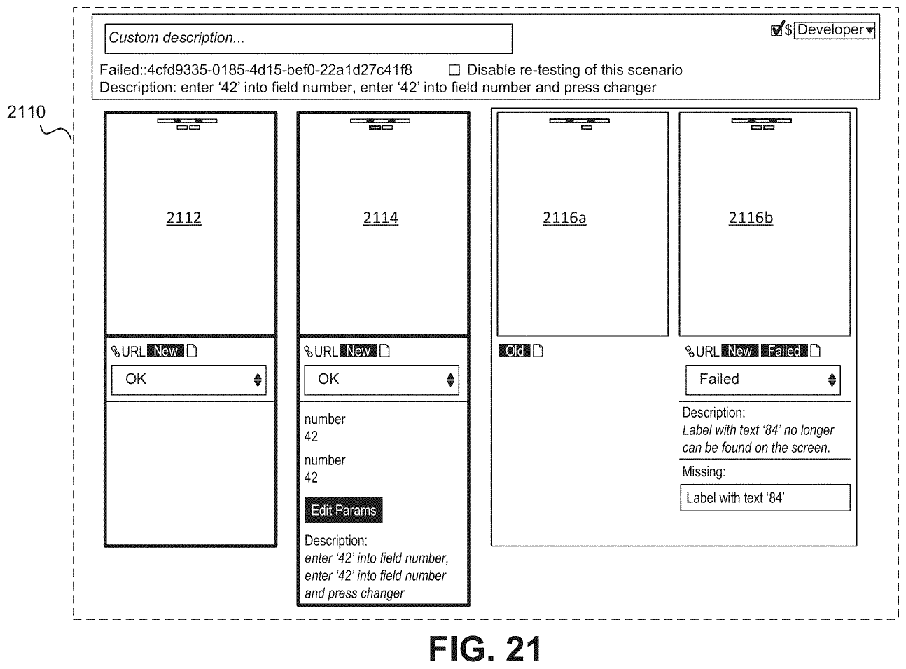

FIG. 21 includes a screen 2110 showing screen captures from the retest. As shown in FIG. 21, screen 2110 includes four total screen captures. Screen captures 2112 and 2114 are similar to screen captures 1812 and 1814 (respectively) of FIG. 18. However, screen 2110 also includes a pair of screen captures 2116a and 2116b that indicate a problem. Here, screen captures 2116a and 2116b represent a comparison between a screen capture from the initial test and a screen capture from the retest. In other words, screen capture 2116a is the same as screen capture 1816 (from FIG. 18) and screen capture 2116b shows a different state of the GUI of the target application 132 following the retest indicating that something in the test scenario is behaving differently. A developer user may review the comparison and determine, for example with the assistance of one or more visual augmentations, that the “add” button is no longer operating as expected. For example, a message is provided below screen capture 2114b indicating that the number “84” is no longer present in the screen even though it appeared in a corresponding screen during the initial test (see e.g., zoomed screen capture 1916).

What is claimed is:

1. A method for performing an automated test of a target application, the method comprising:
crawling, by a computer system, a graphical user interface (GUI) of the target application;
identifying, by the computer system, based on the crawling, a first plurality of interactive elements on a first page of the GUI;
identifying, by the computer system, based on the crawling, a second plurality of interactive elements on a second page of the GUI;
comparing, by the computer system, a plurality of properties of the first plurality of interactive elements on the first page of the GUI and the second plurality of interactive elements on the second page of the GUI; and
determining, by the computer system, based on the comparing, that a first interactive element of the first plurality of interactive elements on the first page of the GUI corresponds to a second interactive element of the second plurality of interactive elements on the second page of the GUI.

2. The method of claim 1, wherein comparing the properties of the first plurality of interactive elements on the first page of the GUI with properties of the second plurality of interactive elements on the second page of the GUI includes:
generating, by the computer system, a matrix including a plurality of similarity values, wherein each of the plurality of similarity values is indicative of a level of similarity between a different one of the first plurality of interactive elements and a different one of the second plurality of interactive elements.

3. The method of claim 2, wherein the matrix includes a plurality of triplet values, (xᵢ, yᵢ, wᵢ), wherein:
xᵢ is an identifier associated with a particular interactive element of the first plurality of interactive elements on the first page of the GUI;
yᵢ is an identifier associated with a particular interactive element of the second plurality of interactive elements on the second page of the GUI; and
wᵢ is a particular similarity value indicative of a level of similarity between the particular interactive element of the first plurality of interactive elements on the first page of the GUI and the particular interactive element of the second plurality of interactive elements on the second page of the GUI.

4. The method of claim 2, wherein generating each similarity value in the matrix includes:
comparing the plurality of properties of a different one of the first plurality of interactive elements with a different one of the second plurality of interactive elements, each of the plurality of properties associated with a respective property value;
identifying, based on the comparison, one or more of the plurality of properties that satisfy a similarity criterion; and
aggregating the property values associated with the one or more properties to generate the similarity value.

5. The method of claim 3, wherein each of the plurality of property values represents a weight assigned to the corresponding property of the plurality of properties.

6. The method of claim 1, wherein the plurality of properties includes any two or more of: path, identifier, name, label, hint, text, class, index, element image, position on page, or color.

7. The method of claim 1, further comprising:
generating, by the computer system, element map data indicative of the correspondence between the first interactive element and the second interactive element.

8. The method of claim 7, further comprising:
processing, by the computer system, the element map data to determine that the first page and the second page are the same page of the GUI of the target application.

9. The method of claim 8, wherein determining that the first page and the second page are the same page of the GUI includes:
determining, based on the element map data, that each of the first plurality of interactive elements corresponds with a different one of the second plurality of interactive elements.

10. The method of claim 7, further comprising:
processing, by the computer system, the element map data to detect an error in the target application.

11. The method of claim 7, further comprising:
processing, by the computer system, the element map data to determine that an interactive element is missing on the first page and/or the second page of the GUI of the target application.

12. The method of claim 7, further comprising:
processing, by the computer system, the element map data to determine that an interactive element is in an incorrect position on the first page and/or the second page of the GUI of the target application.

13. The method of claim 7, further comprising:
storing, by the computer system, the element map data in a data store.

14. The method of claim 13, further comprising:
accessing, by the computer system, the element map data stored in the data store; and
using, by the computer system, the accessed element map data to perform a subsequent automated test of the target application.

15. A computer system for performing an automated test of a target application, the computer system comprising:
a processor; and
a memory coupled to the processor, the memory having instructions stored thereon, which when executed by the processor, cause the computer system to:
crawl a graphical user interface (GUI) of the target application;
identify, based on the crawling, a first plurality of interactive elements on a first page of the GUI;
identify, based on the crawling, a second plurality of interactive elements on a second page of the GUI;
compare a plurality of properties of the first plurality of interactive elements on the first page of the GUI and the second plurality of interactive elements on the second page of the GUI; and
determine, based on the comparison, that a first interactive element of the first plurality of interactive elements on the first page of the GUI corresponds to a second interactive element of the second plurality of interactive elements on the second page of the GUI.

16. The computer system of claim 15, wherein the memory has further instructions stored thereon, which when executed by the processor, cause the computer system to further:
generate element map data indicative of the correspondence between the first interactive element and the second interactive element; and
process the element map data to determine that the first page and the second page are the same page of the GUI of the target application.

17. The computer system of claim 15, wherein the memory has further instructions stored thereon, which when executed by the processor, cause the computer system to further:
generate element map data indicative of the correspondence between the first interactive element and the second interactive element; and
process the element map data to detect an error in the target application.

18. A non-transitory computer-readable medium containing instructions for performing an automated test of a target application, execution of which in a computer system causes the computer system to:
crawl a graphical user interface (GUI) of the target application;
identify, based on the crawling, a first plurality of interactive elements on a first page of the GUI;
identify, based on the crawling, a second plurality of interactive elements on a second page of the GUI;
compare a plurality of properties of the first plurality of interactive elements on the first page of the GUI and the second plurality of interactive elements on the second page of the GUI; and
determine, based on the comparison, that a first interactive element of the first plurality of interactive elements on the first page of the GUI corresponds to a second interactive element of the second plurality of interactive elements on the second page of the GUI.

19. The non-transitory computer-readable medium of claim 18, containing further instructions, execution of which in the computer system causes the computer system to further:
generate element map data indicative of the correspondence between the first interactive element and the second interactive element; and
process the element map data to determine that the first page and the second page are the same page of the GUI of the target application.

20. The non-transitory computer-readable medium of claim 18, containing further instructions, execution of which in the computer system causes the computer system to further:
generate element map data indicative of the correspondence between the first interactive element and the second interactive element; and
process the element map data to detect an error in the target application.
